(19) United States
(12) Patent Application Publication
(10) Pub. No.: US 2009/0059452 A1
(43) Pub. Date: Mar. 5, 2009

(54) Method and apparatus for providing electrostatic discharge protection for a power supply

(75) Inventor: Srinivas Persetty, Santa Clara, CA (US)

Correspondence Address: LAWRENCE M. CHO, P. O. BOX 2144, CHAMPAIGN, IL, 61825, US

(73) Assignee: Altera Corporation

(21) Appl. No.: 11/903,931

(22) Filed: Sep. 25, 2007

Related U.S. Application Data
(60) Provisional application No. 60/967,079, filed on Aug. 31, 2007.

(51) Int. Cl. H02H 9/00

(52) U.S. Cl. 361/56

(57) ABSTRACT

An electrostatic discharge (ESD) protection circuit for protecting a power supply of a device includes a main discharge transistor with a drain coupled to a supply voltage line of the device and a source coupled to ground. The ESD protection circuit also includes a control circuit to modulate a bulk of the main discharge transistor to generate a current discharge path to ground in response to an ESD event.

### RELATED APPLICATION

This application claims priority to provisional U.S. patent application Ser. No. 60/967,079 filed Aug. 31, 2007, titled “Method and Apparatus for Providing Electrostatic Discharge Protection for a Power Supply”, the full and complete subject matter of which is hereby expressly incorporated by reference in its entirety.

### TECHNICAL FIELD

Embodiments of the present invention relate to electrostatic discharge (ESD) protection devices. More specifically, embodiments of the present invention relate to a method and apparatus for providing ESD protection for a power supply using an active bulk triggered clamp solution.

### BACKGROUND

ESD is the transfer of electrostatic charge between two objects. It is a rapid event that usually results when two objects of different potentials come into contact with each other. ESD may also occur when a high electrostatic field develops between two objects in close proximity. ESD has been known to cause device failures in the semiconductor industry.

There are several industry-standard ESD models that define how semiconductor devices are tested for ESD sensitivity under different situations of electrostatic build-up and discharge. For example, the human body model (HBM) simulates the ESD phenomenon where a charged body directly transfers its accumulated electrostatic charge to an ESD-sensitive device. The machine module (MM) simulates a more rapid and severe electrostatic discharge from a charged machine, fixture, or tool to the ESD-sensitive device at a lower potential. The charged device model (CDM) simulates a transfer of accumulated electrostatic charge from a charged device to another body of lower potential.

In the past, traditional ESD protection devices for power supplies included transistor snapback based circuits and resistor-capacitor (RC) triggered circuits. Transistor snapback based circuits make use of the snap back triggering characteristics of parasitic bipolar structure to switch from some critical level of drain-source breakdown into high-conductivity due to avalanche injection. RC triggered based circuits utilized an RC time constant associated with a resistor and capacitor to control a discharge circuit in response to an ESD event.

### SUMMARY

According to an embodiment of the present invention, a method and apparatus for providing electrostatic discharge (ESD) protection for a power supply is disclosed. The method and apparatus utilizes an active bulk triggered clamp solution that does not have the limitation of transistor snapback based circuits which may be difficult to model accurately or RC triggered approaches which may experience problems with fast power supply ramps. In one embodiment, a turn-on path is provided via a main discharge transistor that may be implemented using an NMOS NPN parasitic transistor placed between VCC and VSS. In this embodiment, the main discharge transistor has its drain coupled to a supply voltage line of the device and its source coupled to ground. A control circuit modulates a bulk section of the main discharge transistor to generate a current discharge path to ground in response to an ESD event.

### BRIEF DESCRIPTION OF THE DRAWINGS

The features and advantages of the present invention are illustrated by way of example and are by no means intended to limit the scope of the present invention to the particular embodiments shown.

FIG. 1 illustrates a device on which an electrostatic discharge (ESD) protection circuit resides on according to an exemplary embodiment of the present invention.

FIG. 2 illustrates an exemplary ESD protection circuit according to an embodiment of the present invention.

FIG. 3 illustrates an exemplary ESD protection circuit with a VT drop element according to a first embodiment of the present invention.

FIG. 4 illustrates an exemplary ESD protection circuit with a VT drop element according to a second embodiment of the present invention.

FIG. 5 illustrates an exemplary ESD protection circuit with a gate grounding element according to a first embodiment of the present invention.

FIG. 6 illustrates an exemplary ESD protection circuit with a gate grounding element according to a second embodiment of the present invention.

FIG. 7 is a flow chart illustrating a method for providing ESD protection according to an exemplary embodiment of the present invention.

### DETAILED DESCRIPTION

In the following description, for purposes of explanation, specific nomenclature is set forth to provide a thorough understanding of embodiments of the present invention. It will be apparent to one skilled in the art that specific details in the description may not be required to practice the embodiments of the present invention. In other instances, well-known circuits, devices, and programs are shown in block diagram form to avoid obscuring embodiments of the present invention unnecessarily.

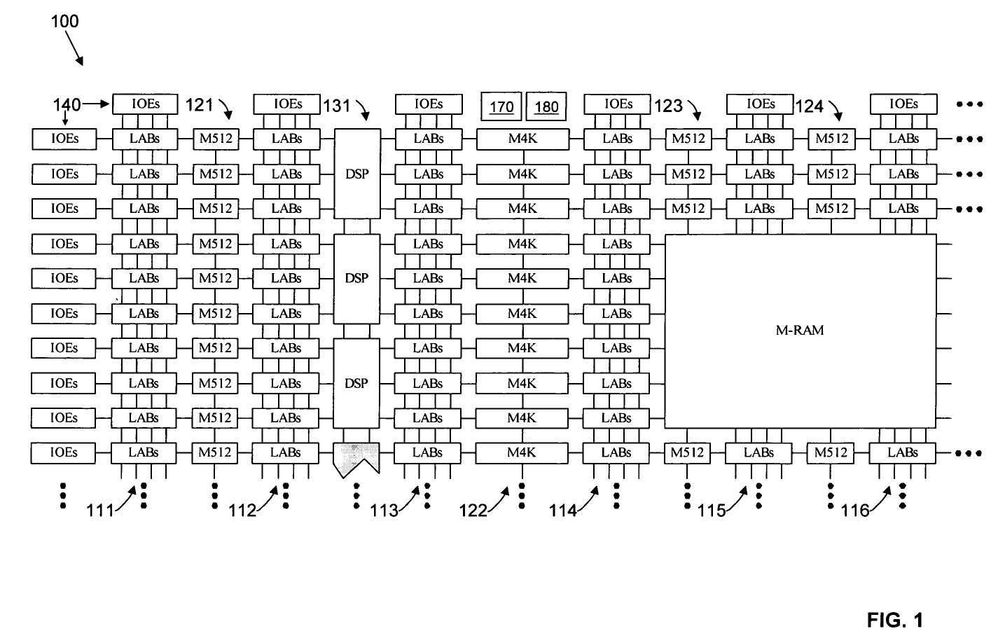

FIG. 1 illustrates a device 100 on which an electrostatic discharge (ESD) protection circuit resides on according to an exemplary embodiment of the present invention. In this example, the device 100 is a target device such as an FPGA which a system may be implemented on. The target device 100 may be a chip having a hierarchical structure that may take advantage of wiring locality properties of circuits formed therein.

The target device 100 includes a plurality of logic-array blocks (LABs). Each LAB may be formed from a plurality of logic blocks, carry chains, LAB control signals, (lookup table) LUT chain, and register chain connection lines. A logic block is a small unit of logic providing efficient implementation of user logic functions. A logic block includes one or more combinational cells, where each combinational cell has a single output, and registers. According to one embodiment of the present invention, the logic block may operate similarly to a logic element (LE), such as those found in Stratix™ manufactured by Altera® Corporation, or a combinational logic block (CLB) such as those found in Virtex™ manufactured by Xilinx® Inc. In this embodiment, the logic block may include a four input lookup table (LUT) with a configurable register. According to an alternate embodiment of the present invention, the logic block may operate similarly to an adaptive logic module (ALM), such as those found in Stratix™ manufactured by Altera® Corporation. LABs are grouped into rows and columns across the target device 100. Columns of LABs are shown as 111-116. It should be appreciated that the logic block may include additional or alternate components.

The target device 100 includes memory blocks. The memory blocks may be, for example, dual port random access memory (RAM) blocks that provide dedicated true dual-port, simple dual-port, or single port memory up to various bits wide at up to various frequencies. The memory blocks may be grouped into columns across the target device in between selected LABs or located individually or in pairs within the target device 100. Columns of memory blocks are shown as 121-124.

The target device 100 includes digital signal processing (DSP) blocks. The DSP blocks may be used to implement multipliers of various configurations with add or subtract features. The DSP blocks include shift registers, multipliers, adders, and accumulators. The DSP blocks may be grouped into columns across the target device 100 and are shown as 131.

The target device 100 includes a plurality of input/output elements (IOEs) 140. Each IOE feeds an I/O pin (not shown) on the target device 100. The IOEs 140 are located at the end of LAB rows and columns around the periphery of the target device 100. Each IOE includes a bidirectional I/O buffer and a plurality of registers for registering input, output, and output-enable signals. When used with dedicated clocks, the registers provide performance and interface support with external memory devices.

The target device 100 may include routing resources such as LAB local interconnect lines, row interconnect lines (“H-type wires”), and column interconnect lines (“V-type wires”) (not shown) to route signals between components on the target device.

The target device 100 includes a plurality of inputs for connecting an external power supply to the target device. Each input may have a corresponding ESD protection circuit. The ESD protection circuit operates to protect a voltage supply line on the target device that corresponds to the input from an ESD event. For example, if an object of higher potential comes in contact with the target device 100 resulting in a voltage spike being present on the voltage supply line, the ESD protection circuit may operate to provide a path to ground to prevent the voltage spike from damaging circuitry on the target device. FIG. 1 illustrates a single input 170 with a single ESD protection circuit. It should be appreciated that additional inputs and ESD protection circuits may reside on the target device 100.

FIG. 1 illustrates an exemplary embodiment of a target device. It should be appreciated that a system may include a plurality of target devices, such as that illustrated in FIG. 1, cascaded together. It should also be appreciated that the target device may include programmable logic devices arranged in a manner different than that on the target device 100. A target device may also include FPGA resources other than those described in reference to the target device 100. Thus, while the invention described herein may be utilized on the architecture described in FIG. 1, it should be appreciated that it may also be utilized on different architectures, such as those employed by Altera® Corporation in its APEX™, Stratix™, Cyclone™, Stratix™ II, Stratix™ III, Cyclone™ II, Cyclone™ III families of chips and those employed by Xilinx® Inc. in its Virtex™, Virtex™ II, Virtex™ II-PRO, Virtex IV™, Virtex V™, and Spartan-3 line of chips.

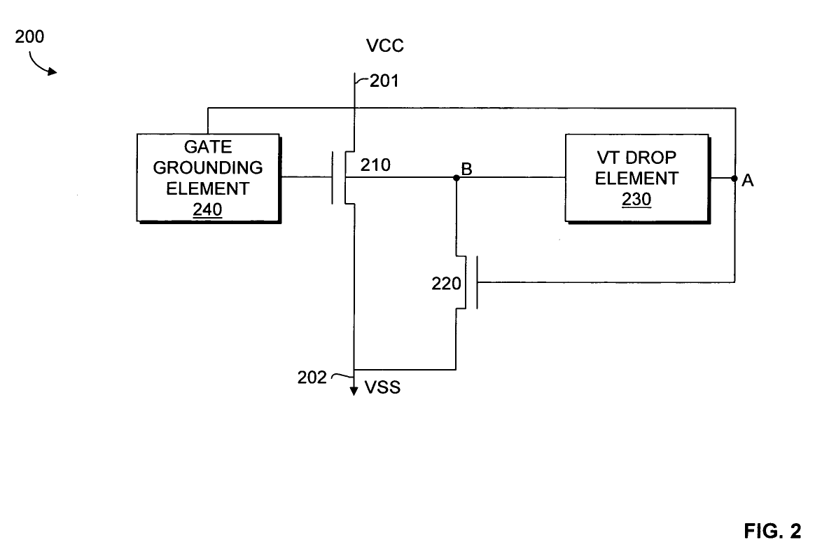

FIG. 2 illustrates an exemplary ESD protection circuit 200 according to an embodiment of the present invention. The ESD protection circuit 200 may be used to implement the ESD protection circuit 180 in FIG. 1. The ESD protection circuit 200 is connected to a supply voltage line for the device which it resides on 201 (VCC). The ESD protection circuit 200 also has a connection to ground 202 (VSS). The ESD protection circuit 200 includes a main discharge transistor 210 with its drain connected to the supply voltage line 201 and its source connected to ground 202. The main discharge transistor 210 provides an active bulk triggered clamp to protect a power supply of a device. The ESD protection circuit 200 includes a grounding transistor 220 with its drain connected to the bulk of the main discharge transistor 210 and its source connected to ground 202. The ESD protection circuit 200 includes a threshold voltage (VT) drop element 230 coupled between the supply voltage line 201 and the drain of the grounding transistor 220. The VT drop element 230 may be configured to drop a voltage equal to or higher than the supply voltage of the device. The grounding transistor 220 and the VT drop element 230 may be referred to as a control circuit. The ESD protection circuit 200 includes a gate grounding element 240. The gate grounding element 240 operates to maintain the voltage at the gate of the main discharge transistor 210 at zero volts so that the main discharge transistor 210 remains in the off state. According to an embodiment of the ESD protection circuit 200, the main discharge transistor 210 and the grounding transistor 220 may be implemented with NMOS transistors.

During normal operation when the device power, VCC, is on, the grounding transistor 220 is activated and provides a path from node B to ground. Upon the occurrence of an ESD event where the voltage level at the supply voltage line 201 surpasses the voltage drop provided by the VT drop element 230, a voltage appears at node B. This modulates the bulk of the main discharge transistor 210 and activates the bipolar creating a path from the supply voltage line 201 to ground 202 via the bulk of the main discharge transistor 210.

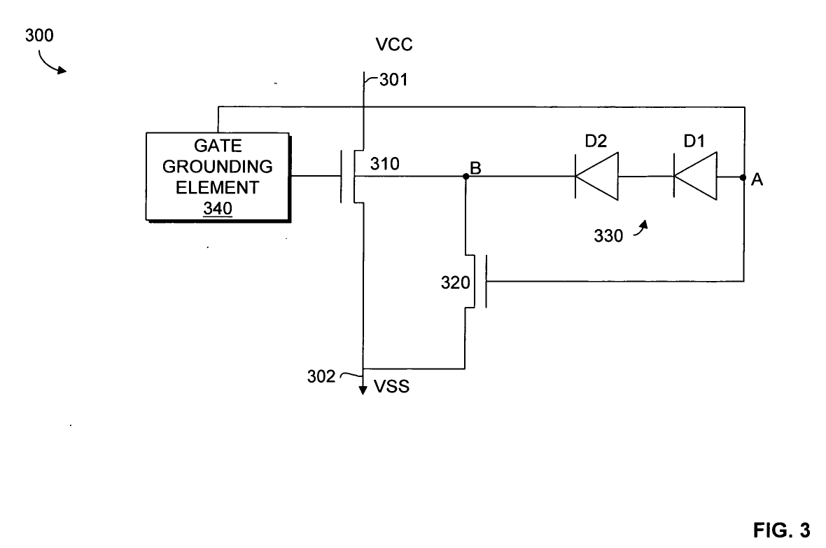

FIG. 3 illustrates an exemplary ESD protection circuit 300 with a VT drop element 330 according to a first embodiment of the present invention. The ESD protection circuit 300 includes a main discharge transistor 310, grounding transistor 320, and gate grounding element 340 that operate similarly to the main discharge transistor 210, grounding transistor 220, and gate grounding element 240 shown in FIG. 2. The ESD protection circuit 300 includes a VT drop element 330 that is implemented using a first diode D1, and a second diode D2. The values of the first and second diodes D1 and D2 may be selected such that it creates a voltage drop between nodes A and B that is greater than the operating voltage of the device at VCC and modulates the bulk of the main discharge transistor 310. Once the voltage at the supply voltage line exceeds the voltage drop of the VT drop element 330, the bipolar of the main discharge transistor 310 is turned on and responds by creating a path to ground 302. Although the VT drop element 330 is shown to be implemented using 2 diodes, it should be appreciated that the VT drop element 330 may be implemented using any number of diodes.

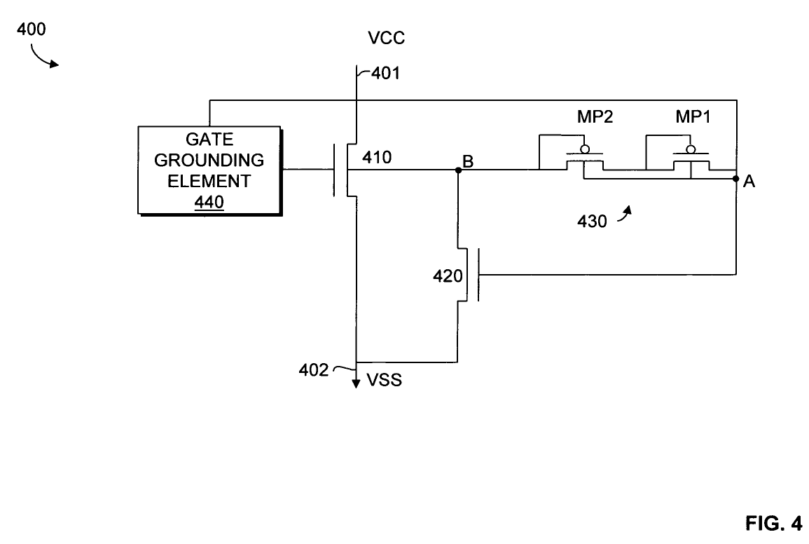

FIG. 4 illustrates an exemplary ESD protection circuit 400 with a VT drop element 430 according to a second embodiment of the present invention. The ESD protection circuit 400 includes a main discharge transistor 410, grounding transistor 420, and gate grounding element 440 that operate similarly to the main discharge transistor 210, grounding transistor 220, and gate grounding element 240 shown in FIG. 2. The ESD protection circuit 400 includes a VT drop element 430 that is implemented using a first PMOS transistor MP1, and a second PMOS transistor MP2. The threshold voltages of the first and second transistors MP1 and MP2 may be selected such that it creates a voltage drop between nodes A and B that is greater than the operating voltage of the device at VCC and modulates the bulk of the main discharge transistor 410. Once the voltage at the supply voltage line exceeds the voltage drop of the VT drop element 430, the bipolar of the main discharge transistor 410 is turned on and responds by creating a path to ground 402. Although the VT drop element 430 is shown to be implemented using 2 PMOS transistors, it should be appreciated that the VT drop element 430 may be implemented using other numbers of transistors. Utilizing transistors as the VT drop element 430 may be more desirable in some instances since transistors typically require less space than diodes.

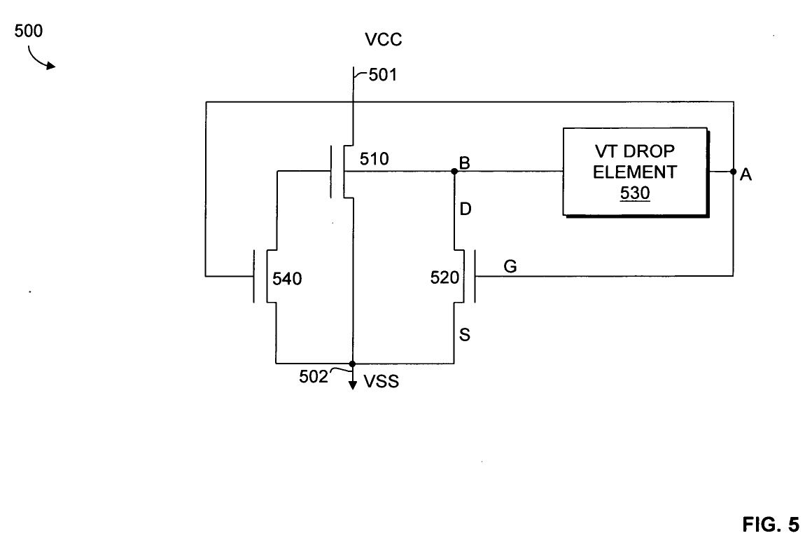

FIG. 5 illustrates an exemplary ESD protection circuit 500 with a gate grounding element 540 according to a first embodiment of the present invention. The ESD protection circuit 500 includes a main discharge transistor 510, grounding transistor 520, and VT drop element 530 that operate similarly to the main discharge transistor 210, grounding transistor 220, and VT drop element 230 shown in FIG. 2. The ESD protection circuit 500 includes a gate grounding element 540 that is implemented using an NMOS transistor. The NMOS transistor 540 has its drain coupled to the gate of the main discharge transistor 510, its source coupled to ground 502, and its gate coupled to the voltage supply line 501. The NMOS transistor 540 is activated when a voltage is applied on the voltage supply line 501 and provides a path from the gate of the main discharge transistor 510 to ground. By keeping the voltage at the gate of the main discharge transistor 510 at ground, the main discharge transistor 510 is maintained at the off state. By providing a soft grounded gate connection, the gate grounding element 540 takes advantage of the capacitive coupling of the ESD protection circuit 500.

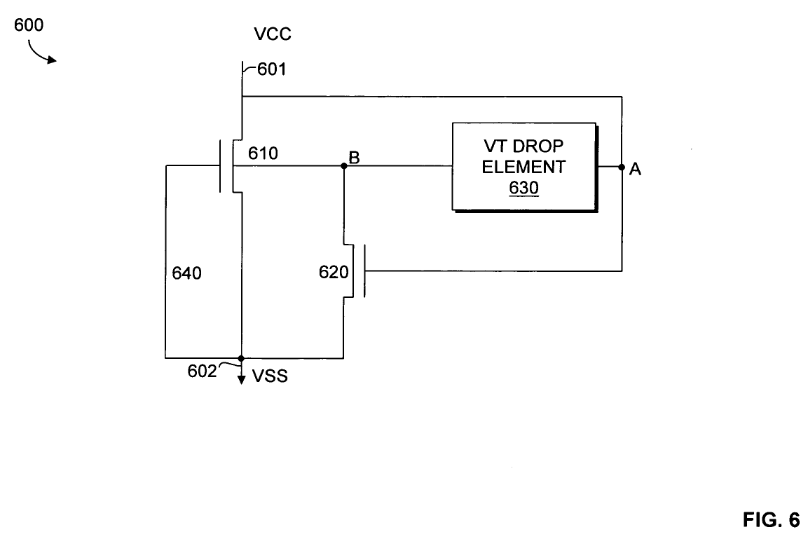

FIG. 6 illustrates an exemplary ESD protection circuit 600 with a gate grounding element 640 according to a second embodiment of the present invention. The ESD protection circuit 600 includes a main discharge transistor 610, grounding transistor 620, and VT drop element 630 that operate similarly to the main discharge transistor 210, grounding transistor 220, and VT drop element 230 shown in FIG. 2. The ESD protection circuit 600 includes a gate grounding element 640 that is implemented with a connection to ground 602. The gate grounding element 640 connects the gate of the main discharge transistor to ground 602. By keeping the voltage at the gate of the main discharge transistor 510 at ground, the main discharge transistor 510 is maintained at the off state.

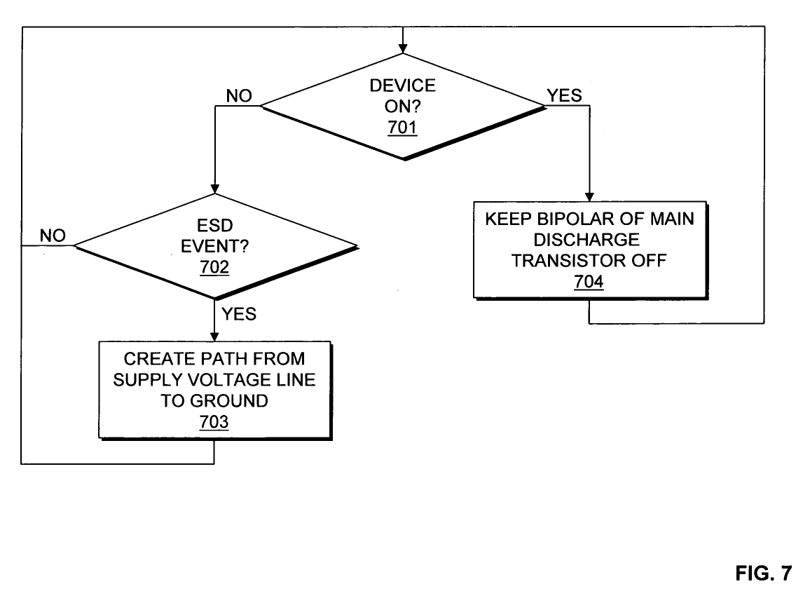

FIG. 7 is a flow chart illustrating a method for providing ESD protection according to an exemplary embodiment of the present invention. The method may be used to provide ESD protection to a supply voltage of a device. At 701, it is determined whether the device is on. According to an embodiment of the present invention, the device is on when VCC is present. If it is determined that the device is on, control proceeds to 704. If it is determined that the device is not on, control proceeds to 702.

At 702, it is determined whether an ESD event has occurred. According to an embodiment of the present invention, an ESD event occurs when a voltage at a supply voltage line of a device is at a level higher than a predetermined supply voltage of the device. If it is determined that an ESD event has occurred control proceeds to 703. If it is determined that an ESD event has not occurred, control returns to 701.

At 703, a path is created from the supply voltage line to ground. According to an embodiment of the present invention, this may be achieved by modulating the bulk section of a main discharge transistor to turn on (activate) its bipolar. Modulating the bulk section of the main discharge transistor may be achieved by applying a voltage at the bulk of the main discharge transistor when the voltage at the supply voltage line exceeds a predetermined level. Control returns to 701.

At 704, a bipolar of the main discharge transistor is kept off. According to an embodiment of the present invention, this may be achieved by maintaining the voltage at the bulk of the main discharge transistor near ground by utilizing a voltage drop element and a grounding transistor. Control returns to 701.

FIG. 7 is a flow chart illustrating a method for providing ESD protection for a power supply according to embodiments of the present invention. Some of the procedures illustrated in this figure may be performed sequentially, in parallel or in an order other than that which is described. The techniques may be also be performed one or more times. It should be appreciated that not all of the techniques described are required to be performed, that additional techniques may be added, that some of the illustrated techniques may be substituted with other techniques, and other specifics may be utilized to practice the procedures described.

In the foregoing specification embodiments of the invention has been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

What is claimed is:

1. An electrostatic discharge (ESD) protection circuit for protecting a power supply of a device, comprising:
a main discharge transistor with a drain coupled to a supply voltage line of the device and a source coupled to ground; and
a control circuit to modulate a bulk of the main discharge transistor to generate a current discharge path to ground in response to an ESD event.

2. The apparatus of claim 1, wherein the control circuit comprises:
a grounding transistor coupled to the supply voltage line of the device and the bulk of the main discharge transistor; and
a threshold voltage (VT) drop element coupled to the supply voltage line and the bulk of the main discharge transistor.

3. The apparatus of claim 2, wherein the grounding transistor provides a path to ground when the device is on.

4. The apparatus of claim 2, wherein the VT drop element is configured to drop a voltage level higher than a supply voltage of the device.

5. The apparatus of claim 2, wherein the VT drop element comprises one or more diodes connected in series.

6. The apparatus of claim 2, wherein the VT drop element comprises one or more PMOS transistors coupled in series.

7. The apparatus of claim 1, wherein the main discharge transistor is an NMOS transistor.

8. The apparatus of claim 2, wherein the grounding transistor is an NMOS transistor.

9. The apparatus of claim 1, further comprising a gate grounding element coupled to a gate of the main discharge transistor.

10. The apparatus of claim 9, wherein the gate grounding element comprises a connection to ground.

11. The apparatus of claim 9, wherein the gate grounding element comprises a NMOS transistor.

12. A field programmable gate array, comprising:
an electrostatic discharge (ESD) protection circuit that includes an active bulk triggered clamp to protect a power supply of the FPGA.

13. The apparatus of claim 12, wherein the ESD protection circuit comprises:
a main discharge transistor with a drain coupled to a supply voltage line of the FPGA and a source coupled to ground; and
a control circuit to modulate a bulk of the main discharge transistor to generate a current discharge path to ground in response to an ESD event.

14. The apparatus of claim 13, wherein the control circuit comprises:
a grounding transistor coupled to the supply voltage line of the device and the bulk of the main discharge transistor; and
a threshold voltage (VT) drop element coupled to the supply voltage line and the bulk of the main discharge transistor.

15. The apparatus of claim 14, wherein the grounding transistor provides a path to ground when the device is on.

16. The apparatus of claim 14, wherein the VT drop element is configured to drop a voltage level higher than a supply voltage of the device.

17. The apparatus of claim 14, wherein the VT drop element comprises one or more diodes connected in series.

18. The apparatus of claim 14, wherein the VT drop element comprises one or more PMOS transistors coupled in series.

19. A method for providing electrostatic discharge (ESD) protection for a power supply of a device, comprising:
modulating a bulk of a main discharge transistor to create a path from a supply voltage line to ground in response to an ESD event.

20. The method of claim 19, wherein modulating the bulk comprises transmitting a voltage from the supply voltage line passed through a threshold voltage drop element to the bulk.

21. The method of claim 19, further comprising maintaining a voltage at the bulk at zero during normal operation.

22. The method of claim 21, wherein maintaining the voltage at the bulk at zero comprises activating a grounding transistor having a gate coupled to the supply voltage line.
